(19) United States
(12) Patent Application Publication
(10) Pub. No.: US 2024/0297942 A1
(43) Pub. Date: Sep. 5, 2024

(54) IMAGE READING APPARATUS

(71) Applicant: KYOCERA Document Solutions Inc., Osaka (JP)

(72) Inventor: Cuong Van DO, Osaka (JP)

(21) Appl. No.: 18/586,353

(22) Filed: Feb. 23, 2024

(30) Foreign Application Priority Data
Mar. 2, 2023 (JP) 2023-031797

(51) Int. Cl. H04N 1/00

(52) U.S. Cl. CPC H04N 1/00779; H04N 1/00602; H04N 1/00705; H04N 1/00809

(57) ABSTRACT

An image sensor reads an image from a document sheet at a reading position. Two document sheet sensors are capable of detecting the document sheet at two positions along boundaries of a reference pass-through area of the document sheet at a detection position more on an upstream side of a conveying direction than the reading position. Two sets of independent roller pairs are arranged with an interval provided therebetween in a width direction at positions between the detection position and the reading position, and rotation speeds thereof can be changed independently. A control portion changes, when the document sheet is detected by one of the two document sheet sensors, a speed ratio of the two sets of independent roller pairs from a reference ratio to a correction ratio during an adjustment period that lasts until the document sheet is no longer detected by both of the two document sheet sensors.

### INCORPORATION BY REFERENCE

This application is based upon and claims the benefit of priority from the corresponding Japanese Patent Application No. 2023-031797 filed on Mar. 2, 2023, the entire contents of which are incorporated herein by reference.

### BACKGROUND

The present disclosure relates to an image reading apparatus capable of correcting a tilt of a document sheet and conveying the document sheet.

The image reading apparatus includes an image sensor. The image reading apparatus may further include a document sheet conveying device.

The document sheet conveying device feeds a document sheet placed on a supply tray to a conveying path and further conveys the document sheet along the conveying path. The image sensor reads, at a reading position on the conveying path, an image from the document sheet that passes through the reading position.

Further, the image reading apparatus may include a tilt correction device which corrects a tilt of the conveyed document sheet (see, for example, Patent Document 1).

The tilt correction device includes two document sheet sensors which detect the document sheet at two positions in a width direction in a pass-through area of the document sheet. A time lag in the detection of the document sheet by the two document sheet sensors expresses a magnitude of the tilt of the document sheet.

Further, the tilt correction device may include two sets of independent roller pairs that are arranged next to each other in the width direction, and rotation speeds of the two sets of independent roller pairs can be changed independently. The tilt correction device corrects the tilt of the document sheet by changing the rotation speeds of the two sets of independent roller pairs according to the time lag.

### SUMMARY

An image reading apparatus according to an aspect of the present disclosure includes a plurality of sets of conveying roller pairs, an image sensor, two document sheet sensors, and a control portion. The plurality of sets of conveying roller pairs convey a document sheet along a conveying path. The image sensor reads an image from the document sheet at a reading position on the conveying path. The two document sheet sensors are capable of detecting the document sheet at two positions along boundaries of a reference pass-through area of the document sheet at a detection position more on an upstream side of a conveying direction of the document sheet than the reading position on the conveying path. The control portion controls operations of the plurality of sets of conveying roller pairs. The plurality of sets of conveying roller pairs include two sets of independent roller pairs which are arranged with an interval provided therebetween in a width direction intersecting with the conveying direction at positions between the detection position and the reading position on the conveying path, and rotation speeds of the two sets of independent roller pairs can be changed independently. The control portion changes, when the document sheet is detected by one of the two document sheet sensors, a speed ratio of the two sets of independent roller pairs from a preset reference ratio to a correction ratio corresponding to a detection status of the two document sheet sensors during an adjustment period that lasts until the document sheet is no longer detected by both of the two document sheet sensors.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image reading apparatus according to an embodiment;

FIG. 2 is a block diagram showing a configuration of a control portion in an image forming apparatus according to the embodiment;

FIG. 3 is a diagram showing a configuration of a peripheral portion of a tilt correction device in the image forming apparatus according to the embodiment;

FIG. 4 is a diagram showing a configuration of two document sheet sensors of the tilt correction device in the image forming apparatus according to the embodiment;

FIG. 5 is a diagram showing a state where a sheet that is tilted with a left side preceding a right side is entering the tilt correction device of the image forming apparatus according to the embodiment;

FIG. 6 is a diagram showing a state where a sheet that is tilted with the right side preceding the left side is entering the tilt correction device of the image forming apparatus according to the embodiment; and

FIG. 7 is a diagram showing a state where the tilt of the sheet is corrected by the tilt correction device of the image forming apparatus according to the embodiment.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

### [Configuration of Image Reading Apparatus 1]

An image reading apparatus 1 according to the embodiment is an apparatus capable of conveying a document sheet 9 and reading an image from the conveyed document sheet 9.

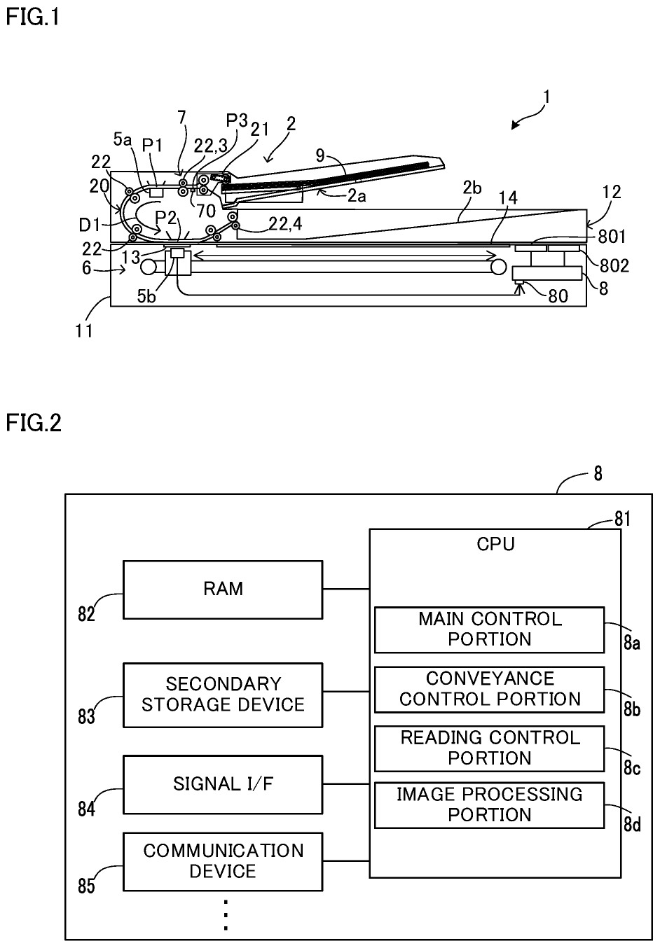

As shown in FIG. 1, the image reading apparatus 1 includes a body portion 11 and a cover portion 12 which covers an upper surface of the body portion 11. The body portion 11 is a housing which houses various types of equipment.

The cover portion 12 is coupled to the body portion 11 and is supported while being displaceable between a closing position at which it covers the upper surface of the body portion 11 and an opening position at which it opens the upper surface of the body portion 11. In other words, the cover portion 12 is supported while being capable of opening and closing the upper surface of the body portion 11.

Further, the image reading apparatus 1 includes contact glass 13 and platen glass 14 arranged on an upper surface of the body portion 11. The contact glass 13 and the platen glass 14 are each a transparent plate member.

Furthermore, the image reading apparatus 1 includes a document sheet conveying device 2, two image sensors 5a and 5b, a sensor movement mechanism 6, a control device 8, an operation device 801, a display device 802, and the like. The document sheet conveying device 2 is incorporated into the cover portion 12.

The document sheet conveying device 2 includes a supply tray 2a, a discharge tray 2b, a conveying path 20, a sheet feed mechanism 21, a plurality of sets of conveying roller pairs 22, and the like. The document sheet conveying device 2 is arranged in the cover portion 12. Document sheets 9 can be stacked on each of the supply tray 2a and the discharge tray 2b.

The conveying path 20 is a path for conveying the document sheet 9 inside the cover portion 12. The conveying path 20 starts from an inlet corresponding to the supply tray 2a and reaches an outlet corresponding to the discharge tray 2b via a first reading position P1 and a second reading position P2.

The sheet feed mechanism 21 feeds the document sheets 9 on the supply tray 2a one by one to the conveying path 20. The plurality of sets of conveying roller pairs 22 rotate to convey the document sheet 9 along the conveying path 20. The plurality of sets of conveying roller pairs 22 include a discharge roller pair 4 which discharges the document sheet 9 onto the discharge tray 2b from the conveying path 20.

Each of the first image sensor 5a and the second image sensor 5b includes a line sensor that includes a plurality of photoelectric conversion elements arrayed in a straight line. For example, each of the first image sensor 5a and the second image sensor 5b is a CIS (Contact Image Sensor) unit including a light-emitting portion, a lens, and the line sensor.

It is noted that the second image sensor 5b may be a CCD (Charge Coupled Device)-type sensor.

The first image sensor 5a is arranged opposed to the first reading position P1 of the conveying path 20 inside the cover portion 12. The first image sensor 5a is arranged such that a longitudinal direction thereof is set along a width direction D2. The width direction D2 is a direction orthogonal to a conveying direction D1 of the document sheet 9.

The first image sensor 5a reads, at the first reading position P1, an image from a first surface of the document sheet 9 that passes through the first reading position P1.

The second image sensor 5b and the sensor movement mechanism 6 are arranged inside the body portion 11. The sensor movement mechanism 6 causes the second image sensor 5b to move along the contact glass 13 and the platen glass 14.

When the document sheet conveying device 2 conveys the document sheet 9, the sensor movement mechanism 6 retains the second image sensor 5b at a position opposing the second reading position P2 via the contact glass 13. The second image sensor 5b is retained by the sensor movement mechanism 6 in a state where a longitudinal direction thereof is set along the width direction D2.

Further, when the document sheet 9 is placed on the platen glass 14, the sensor movement mechanism 6 causes the second image sensor 5b to move along the platen glass 14.

The second image sensor 5b reads, at the second reading position P2, an image from a second surface of the document sheet 9 that passes through the second reading position P2.

In the present embodiment, an upper surface of the document sheet 9 placed on the supply tray 2a is the first surface, and a lower surface of the document sheet 9 placed on the supply tray 2a is the second surface.

Moreover, when moving along the platen glass 14, the second image sensor 5b reads an image from the lower surface of the document sheet 9 on the platen glass 14.

The first image sensor 5a and the second image sensor 5b each output image signals representing an image read from the document sheet 9. The image signals are converted into digital image data by an AFE (Analog Front End) 80 and transmitted to the control device 8.

The operation device 801 is a device that accepts operations from a person and includes, for example, operation buttons and a touch panel. The display device 802 is a device that displays information and includes, for example, a panel display device such as a liquid crystal display unit.

The control device 8 executes various types of data processing and control of the image reading apparatus 1. As shown in FIG. 2, the control device 8 includes a CPU (Central Processing Unit) 81 and peripheral equipment such as a RAM (Random Access Memory) 82, a secondary storage device 83, and a signal interface 84. In addition, the control device 8 also includes a communication device 85 capable of communicating with other devices.

The secondary storage device 83 is a nonvolatile computer-readable storage device. The secondary storage device 83 is capable of storing and updating computer programs and various types of data. For example, one or both of a flash memory and a hard disk drive is/are adopted as the secondary storage device 83.

The signal interface 84 converts signals output from various sensors into digital data and transmits the digital data obtained by the conversion to the CPU 81. Further, the signal interface 84 converts control instructions output by the CPU 81 into control signals and transmits the control signals to the equipment to be controlled.

The CPU 81 is a processor which executes the computer programs to thus execute various types of data processing and control. The RAM 82 is a volatile computer-readable storage device. The RAM 82 temporarily stores the computer programs executed by the CPU 81 and data to be output and referenced by the CPU 81 during a process of executing various types of processing.

The CPU 81 includes a plurality of processing modules that are realized by executing the computer programs. The plurality of processing modules include a main control portion 8a, a conveyance control portion 8b, a reading control portion 8c, an image processing portion 8d, and the like.

The main control portion 8a executes control to start various types of processing in accordance with operations made to the operation device 801, control of the display device 802, and the like. The conveyance control portion 8b controls the document sheet conveying device 2 to control conveyance of the document sheet 9.

The reading control portion 8c controls the first image sensor 5a, the second image sensor 5b, and the sensor movement mechanism 6 to cause the first image sensor 5a and the second image sensor 5b to execute reading processing. The reading processing is processing of reading an image from the document sheet 9.

The image processing portion 8d executes various types of image processing on the image data obtained by the reading processing.

The image reading apparatus 1 further includes a tilt correction device 7 (see FIG. 1) which corrects a tilt of the document sheet 9 conveyed along the conveying path 20. The tilt correction device 7 will be described later in detail.

Incidentally, when executing an operation of correcting a tilt of the document sheet 9, a conventional tilt correction device is unable to confirm that the tilt of the document sheet 9 has been corrected.

Meanwhile, the tilt correction device 7 has a configuration for executing the operation of correcting the tilt of the document sheet 9 until it is confirmed that the tilt of the document sheet 9 has been corrected. Hereinafter, the configuration of the tilt correction device 7 will be described.

### [Configuration of Tilt Correction Device 7]

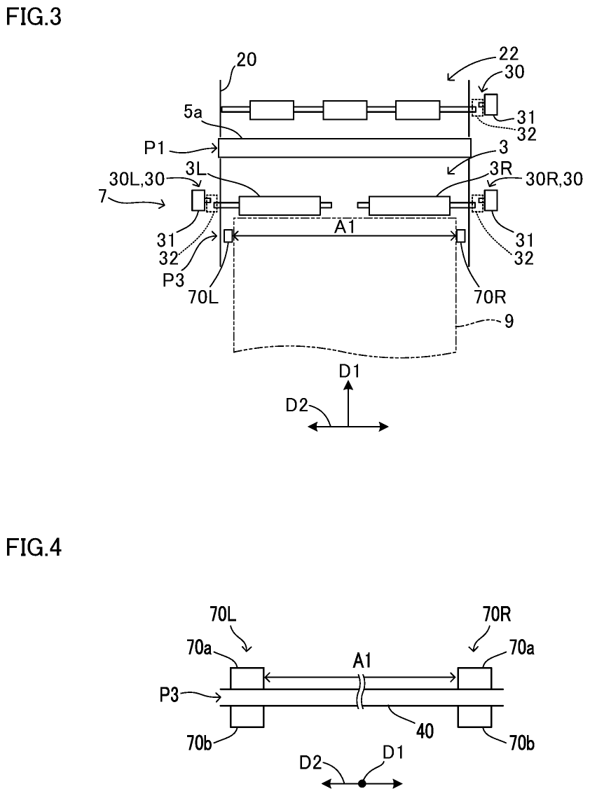

As shown in FIG. 3, the tilt correction device 7 includes two document sheet sensors 70L and 70R and two sets of independent roller pairs 3.

The two document sheet sensors 70L and 70R are capable of detecting the document sheet 9 at two positions along boundaries of a reference pass-through area A1 of the document sheet 9 at a detection position P3 of the conveying path 20. The detection position P3 is a position more on an upstream side of the conveying direction D1 than the first reading position P1 on the conveying path 20 (see FIG. 1 and FIG. 3).

The reference pass-through area A1 is a pass-through area of the document sheet 9 in a case where the document sheet 9 passes through the detection position P3 with a tilt within an allowable range. The reference pass-through area A1 is predetermined in correspondence with the size of the document sheet 9.

In the present embodiment, each of the document sheet sensors 70L and 70R is a transmissive photosensor (see FIG. 4). The transmissive photosensor includes a light-emitting portion 70a and a light-receiving portion 70b arranged opposed to each other via the conveying path 20.

The light-emitting portion 70a is a light source that emits detection light toward the conveying path 20. The light-receiving portion 70b is a photoelectric conversion element. The light-receiving portion 70b receives the detection light that has passed through the conveying path 20 and detects a received light amount.

The received light amount detected by the light-receiving portion 70b falling below a preset reference amount means that the document sheet 9 has been detected.

The two sets of independent roller pairs 3 are included in the plurality of sets of conveying roller pairs 22. The conveyance control portion 8b controls operations of the plurality of sets of conveying roller pairs 22 including the two sets of independent roller pairs 3. It is noted that the conveyance control portion 8b which controls the two sets of independent roller pairs 3 constitutes a part of the tilt correction device 7.

The two sets of independent roller pairs 3 are arranged with an interval provided therebetween in the width direction D2 at positions between the detection position P3 and the first reading position P1 on the conveying path 20. The two sets of independent roller pairs 3 are arranged on both sides with respect to a center of the conveying path 20 in the width direction D2. The width direction D2 is a direction intersecting with the conveying direction D1.

Rotation speeds of the two sets of independent roller pairs 3 can be changed independently. Specifically, the two sets of independent roller pairs 3 include a first independent roller pair 3L and a second independent roller pair 3R that are respectively arranged on a left side and a right side with respect to the center of the conveying path 20 in the width direction D2.

Further, the document sheet conveying device 2 includes a plurality of drive mechanisms 30 which cause the plurality of sets of conveying roller pairs 22 to rotate. Each of the drive mechanisms 30 includes a motor 31 as a drive source and a gear mechanism 32 that transmits a rotational force of the motor 31 to the roller pair.

Furthermore, the plurality of drive mechanisms 30 include a first drive mechanism 30L which causes the first independent roller pair 3L to rotate and a second drive mechanism 30R which causes the second independent roller pair 3R to rotate. The conveyance control portion 8b controls the speed of the motor 31 of each of the first drive mechanism 30L and the second drive mechanism 30R independently so as to enable the two sets of independent roller pairs 3 to rotate at the same speed or at different speeds.

Specifically, when starting conveyance of the document sheet 9, the conveyance control portion 8b causes the two sets of independent roller pairs to rotate such that a speed ratio thereof becomes a preset reference ratio. An initial value of the reference ratio is a speed ratio of 1:1. In this case, the conveyance control portion 8b causes the two sets of independent roller pairs to rotate at the same speed.

As shown in FIG. 3, when the document sheet 9 is conveyed with a tilt within an allowable range, both of the two document sheet sensors 70L and 70R do not detect the document sheet 9.

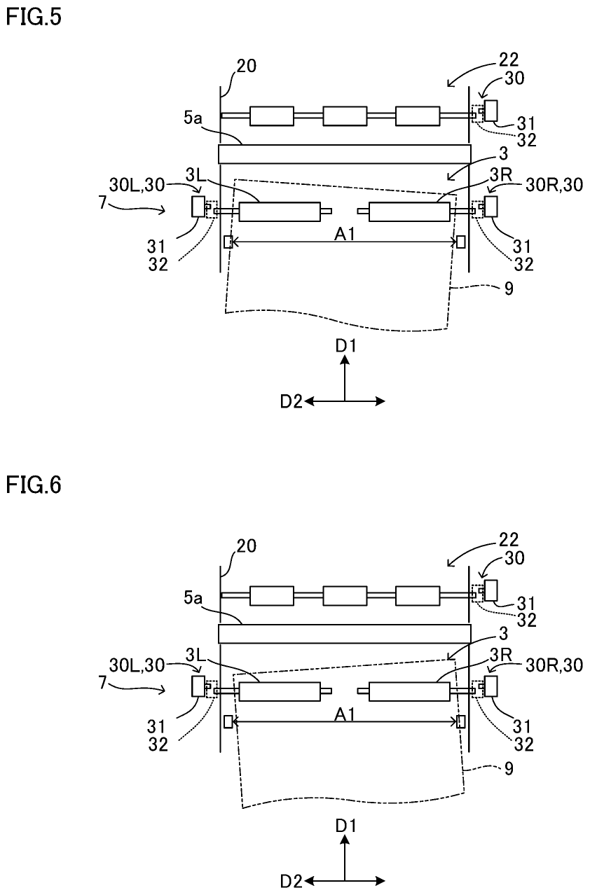

On the other hand, when the document sheet 9 is conveyed while being tilted in a range exceeding the allowable range, one of the two document sheet sensors 70L and 70R corresponding to a tilt direction of the document sheet 9 detects the document sheet 9 (see FIG. 5 and FIG. 6).

Specifically, when the document sheet 9 is tilted in a direction in which a left tip end portion precedes a right tip end portion, the first document sheet sensor 70L detects the document sheet 9 (see FIG. 5). On the other hand, when the document sheet 9 is tilted in a direction in which the right tip end portion precedes the left tip end portion, the second document sheet sensor 70R detects the document sheet 9 (see FIG. 6).

In descriptions below, a period from a time point the document sheet 9 is detected by one of the two document sheet sensors 70L and 70R every time one document sheet 9 is conveyed to a time point the document sheet 9 is no longer detected by both of the two document sheet sensors 70L and 70R will be referred to as an adjustment period.

It is noted that when the document sheet 9 is conveyed while being tilted within the allowable range, the adjustment period does not occur.

Moreover, one of the two document sheet sensors 70L and 70R that has detected the document sheet 9 will be referred to as a target sensor. Similarly, one of the two sets of independent roller pairs 3 corresponding to the target sensor will be referred to as a target roller pair.

When the document sheet 9 is detected by one of the two document sheet sensors 70L and 70R every time one document sheet 9 is conveyed, the conveyance control portion 8b changes the speed ratio of the two sets of independent roller pairs 3 from the reference ratio to a correction ratio corresponding to a detection status of the two document sheet sensors 70L and 70R during the adjustment period.

Specifically, during the adjustment period, the conveyance control portion 8b causes the target roller pair to rotate at a speed lower than that before the adjustment period. In this case, regarding the speed ratio of the target roller pair, the correction ratio is smaller than the reference ratio.

For example, when the first document sheet sensor 70L is the target sensor, the conveyance control portion 8b causes, during the adjustment period, the first independent roller pair 3L to operate at a speed lower than that before the adjustment period and causes the second independent roller pair 3R to operate at a speed that is the same as that before the adjustment period (see FIG. 5).

On the other hand, when the second document sheet sensor 70R is the target sensor, the conveyance control portion 8b causes, during the adjustment period, the second independent roller pair 3R to operate at a speed lower than that before the adjustment period and causes the first independent roller pair 3L to operate at a speed that is the same as that before the adjustment period (see FIG. 6).

Further, when the first document sheet sensor 70L is the target sensor, the conveyance control portion 8b may cause, during the adjustment period, the first independent roller pair 3L to operate at a first correction speed and also cause the second independent roller pair 3R to operate at a second correction speed.

The first correction speed is a speed obtained by multiplying the speed obtained before the adjustment period by a first coefficient. The first coefficient is smaller than 1. The second correction speed is a speed obtained by multiplying the speed obtained before the adjustment period by a second coefficient. The second coefficient is smaller than 1 and larger than the first coefficient.

Similarly, when the second document sheet sensor 70R is the target sensor, the conveyance control portion 8b may cause, during the adjustment period, the second independent roller pair 3R to operate at the first correction speed and also cause the first independent roller pair 3L to operate at the second correction speed.

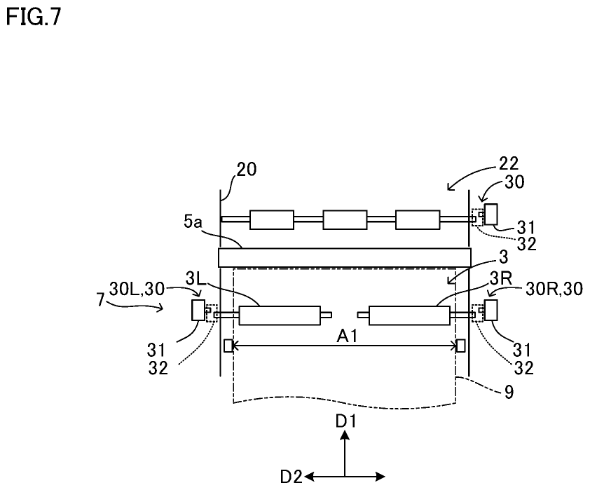

In the tilt correction device 7, a state where both of the two document sheet sensors 70L and 70R no longer detect the document sheet 9 due to the operation of the adjustment period is a state where the tilt of the document sheet 9 has been corrected (see FIG. 7). In other words, the tilt correction device 7 executes the operation of correcting the tilt of the document sheet 9 until it is confirmed that the tilt of the document sheet 9 has been corrected.

Further, by lowering the speed of the target roller pair during the adjustment period, a situation where the document sheet 9 reaches the first reading position P1 without the tilt thereof being corrected sufficiently is avoided.

The document sheet conveying device 2 may have characteristics of constantly conveying the document sheet 9 in a state where the document sheet 9 is tilted in the same direction. In this case, it is desirable for the conveyance control portion 8b to be able to set the reference ratio with which it becomes difficult for the tilt of the document sheet 9 to occur.

For example, the conveyance control portion 8b stores, in the secondary storage device 83, correction performance information that represents a length of the adjustment period and the correction ratio used during the adjustment period every time one document sheet 9 is conveyed.

In the above-described case, the conveyance control portion 8b executes calibration processing for setting the reference ratio based on the correction performance information.

In the present embodiment, when the correction ratios are the same, the adjustment period expresses a magnitude of the tilt of the document sheet 9. Moreover, when the adjustment periods are the same, the correction ratio expresses the magnitude of the tilt of the document sheet 9.

The conveyance control portion 8b executes the calibration processing when, in the correction performance information, the correction ratio expressing that a specific one of the two sets of independent roller pairs 3 is the target roller pair is consecutively obtained a number of times exceeding a predetermined number of times.

For example, the conveyance control portion 8b applies a mean value of the lengths of the adjustment periods and a mean value of the reference ratios in the correction performance information to a predetermined first conversion formula, to thus derive an estimate value of the tilt of the document sheet 9.

Further, the conveyance control portion 8b applies the derived estimate value to a predetermined second conversion formula, to thus derive a correction value of the reference ratio. Furthermore, the conveyance control portion 8b multiplies the existing reference ratio by the correction value to thus set a new reference ratio.

By executing the calibration processing, the tilt of the document sheet 9 due to the characteristics of the document sheet conveying device 2 can be prevented from occurring.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image reading apparatus, comprising:
a plurality of sets of conveying roller pairs which convey a document sheet along a conveying path;
an image sensor which reads an image from the document sheet at a reading position on the conveying path;
two document sheet sensors capable of detecting the document sheet at two positions along boundaries of a reference pass-through area of the document sheet at a detection position more on an upstream side of a conveying direction of the document sheet than the reading position on the conveying path; and
a control portion which controls operations of the plurality of sets of conveying roller pairs, wherein
the plurality of sets of conveying roller pairs include two sets of independent roller pairs which are arranged with an interval provided therebetween in a width direction intersecting with the conveying direction at positions between the detection position and the reading position on the conveying path, and rotation speeds of the two sets of independent roller pairs can be changed independently, and
the control portion changes, when the document sheet is detected by one of the two document sheet sensors, a speed ratio of the two sets of independent roller pairs from a preset reference ratio to a correction ratio corresponding to a detection status of the two document sheet sensors during an adjustment period that lasts until the document sheet is no longer detected by both of the two document sheet sensors.

2. The image reading apparatus according to claim 1, wherein
during the adjustment period, the control portion causes a target roller pair corresponding to one of the two document sheet sensors that has detected the document sheet out of the two sets of independent roller pairs to operate at a speed lower than that before the adjustment period.

3. The image reading apparatus according to claim 1, wherein
the control portion records correction performance information representing a length of the adjustment period and the correction ratio used during the adjustment period in a nonvolatile storage device, and is capable of executing calibration processing for setting the reference ratio based on the correction performance information.

4. The image reading apparatus according to claim 1, wherein
each of the two document sheet sensors is a transmissive photosensor which includes a light-emitting portion and a light-receiving portion arranged opposed to each other via the conveying path.
